(19) United States
(12) Patent Application Publication
(10) Pub. No.: US 2003/0022656 A1
(43) Pub. Date: Jan. 30, 2003

(54) Position prediction for authentication of a mobile transmitter

(76) Inventors: Harris O. Hinnant JR., Seattle, WA (US); David N. Olmstead, Bainbridge Island, WA (US)

Correspondence Address: STOEL RIVES LLP, 900 SW FIFTH AVENUE, SUITE 2600, PORTLAND, OR, 97204, US

(21) Appl. No.: 09/877,663

(22) Filed: Jun. 8, 2001

(51) Int. Cl. H04M 1/66

(52) U.S. Cl. 455/410; 455/456; 455/435

(57) ABSTRACT

The present invention enables authentication of a mobile source by verifying that a reported position corresponds to a predicted position within a dynamically defined region of uncertainty. The dynamically defined region of uncertainty can express the statistical confidence of the authentication results. The region of uncertainty is dynamically defined by incorporating position, mobility vector, and other data that are determined during the authentication process.

### TECHNICAL FIELD

The present invention relates to the field of authentication of mobile transmitters and other mobile data sources and, in particular, to verification that a reported position corresponds to a predicted position within a dynamically defined region of uncertainty expressing a level of statistical confidence in the authentication procedure.

### BACKGROUND OF THE INVENTION

In fields such as telematics and other areas where mobile transmitters and other mobile data sources (“mobile sources”) participate in communications sessions, there exists a need to authenticate the mobile source sending the transmissions to ensure that the communication was received from an authorized source. One example of a communications session would be a wireless transmission between a mobile source and stationary call center. Authentication of mobile sources in a wireless network can be thought of as adding a new dimension pertaining to the maintenance of what equates to “personal space.” This personal space can be used to authenticate the identity of the mobile source, or to ensure that each of multiple mobile sources on a mobile network do not violate the personal space of another mobile source. An exemplary application of this latter use would be in a collision avoidance system.

A typical authentication procedure involves verifying the identity of a discrete mobile source to determine that a received transmission (or series of transmissions over time) purporting to be from the identifiable mobile source is, in fact, from that mobile source. This need exists in order to ensure that unauthorized transmissions are not mistaken to be originating from an authorized source. Simply including an authentication number or similar mobile source identifier is often ineffective. If the transmission is intercepted, the identifier can be copied and used to authenticate an unauthorized source. In order to provide more reliable authentication procedures, criteria should be established that are not as easy to mimic as a static identification number or similar identifier.

Some systems designed to authenticate a mobile source adopt authentication procedures incorporating changing data, such as data representing the location of the mobile source. The actual location of the mobile source can be determined through conventional methods well known to those skilled in the art, such as with a global positioning system (GPS) receiver incorporated by the mobile source. While these systems have some advantages, they have significant limitations as well. For example, many such systems require human interaction to authenticate the mobile source. Once data is received from a mobile source, a human reviews the data to determine authenticity or plausibility of the mobile source location. Because of their dependency on human input, systems such as these are expensive, inconsistent, and unreliable. These systems also make it difficult to provide a quantifiable degree of certainty in the authentication results, often settling for a “good enough” standard for authentication.

Other systems have tried to remove the human factor by automating the authentication procedure. However, even these systems have substantial limitations. Often automated systems require the use of position histories or predefined tables of acceptable locations for a mobile source. A mobile source is only authenticated if it is within the history of acceptable positions. While such systems may work reasonably well for mobile sources that stay within the confines of preestablished limits, they are relatively useless for authentication of mobile sources that frequently enter new areas or locations.

Automated systems have also used characteristics of a mobile source in an attempt to predict its next location. For example, characteristics such as the speed at which the mobile source is traveling are used to predict where the mobile source will be at a known subsequent time. The actual position data received from the mobile source is then compared to this expected position. Unfortunately, because characteristics such as the speed of a mobile source can change over time, the actual position data rarely matches the expected position exactly. In order to prevent all measurements from failing the authentication procedure, automated systems have implemented an acceptable margin of error. In prior systems, this margin of error has been represented by employing a predefined region surrounding the expected position. If the actual position is within the predefined region, the mobile source is authenticated. However, by predefining the region for authentication, the system foregoes the ability to customize the authentication procedures to the variable characteristics of the mobile source. As the speed of the mobile source increases, the region of uncertainty should similarly increase to compensate for the greater potential error in the predicted position due to the larger distance the mobile source can travel over a discrete period of time. Predefining regions of uncertainty precludes achievement of this flexibility. Also, predefined regions of uncertainty only permit affirmative or negative authentication results. Such “yes or no” authentication procedures do not indicate a meaningful level of statistical confidence in the authentication results.

What is needed is a way to authenticate a mobile source by incorporating the mobile source's variable characteristics to dynamically define a region of uncertainty that expresses authentication results in terms of statistical confidence levels. The present invention fulfills this need.

### SUMMARY OF THE INVENTION

The present invention enables authentication of a mobile source by verifying that a reported position corresponds to a predicted position within a dynamically defined region of uncertainty. The dynamically defined region of uncertainty can express the statistical confidence of the authentication results. In an embodiment of the present invention, the mobile source transmits position data to a receiver (which can be stationary or also mobile). Position data can be determined by the mobile source through use of a global positioning system (GPS) receiver, an internal navigation system (INS), or an integrated GPS/INS. The authentication procedure begins with receiving data defining a first position, a mobility vector, and an initial region of statistical accuracy for a mobile source at a first time. Next, data defining a second position of the mobile source is received at a second time, and the time differential between the second time and the first time is calculated. A position is predicted for the mobile source at the second time based on the first position, the mobility vector, and the calculated time differential. Next, a region of uncertainty can be dynamically defined at the second time using the first position, predicted position, mobility vector, initial region of statistical accuracy, and time differential. The dynamically defined region of uncertainty is defined to encompass the predicted position and represent a statistical standard deviation of the predicted position. Defining the dynamically defined region of uncertainty in this manner expresses a level of statistical confidence in the predicted position. Finally, the authentication procedure verifies that the second position is within the dynamically defined region of uncertainty.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 schematically illustrates various components of a system consistent with the present invention.

FIG. 2 conceptually illustrates an implementation of the invention of FIG. 1.

FIG. 3 is a flow diagram of a process consistent with the present invention.

FIG. 4 depicts an authentication procedure flow diagram implementing the position prediction authentication procedure of FIG. 3 as one component.

### DETAILED DESCRIPTION OF A PREFERRED EMBODIMENT

A preferred embodiment of the present invention allows for the authentication of a mobile data transmitter or other mobile source, after an initial contact and during follow-up contacts, by comparing the mobile source's reported position to a predicted position. The reported position can be determined by a navigational system such as a global positioning system (GPS), inertial navigation system (INS), or INS integrated with GPS onboard the mobile source. The reported position can be represented in one, two, or three dimensions, and can use axes such as north, east, and down. Latitude, longitude, and attitude can also be used. In addition to a Cartesian coordinate system, a polar coordinate system can also be employed by the present invention. The number of dimensions employed can depend on the expected or possible range of motion for the mobile source being authenticated. Additionally, the navigational system can provide time information, a mobility vector, and a statistical accuracy (i.e, a measure of confidence) of the position for the mobile source. Using this information, it is possible to predict where the mobile source will be the next time a call center receives a data transmission from the mobile source. If the mobile source is not located within a dynamically defined region of uncertainty encompassing the predicted position, authentication will not occur.

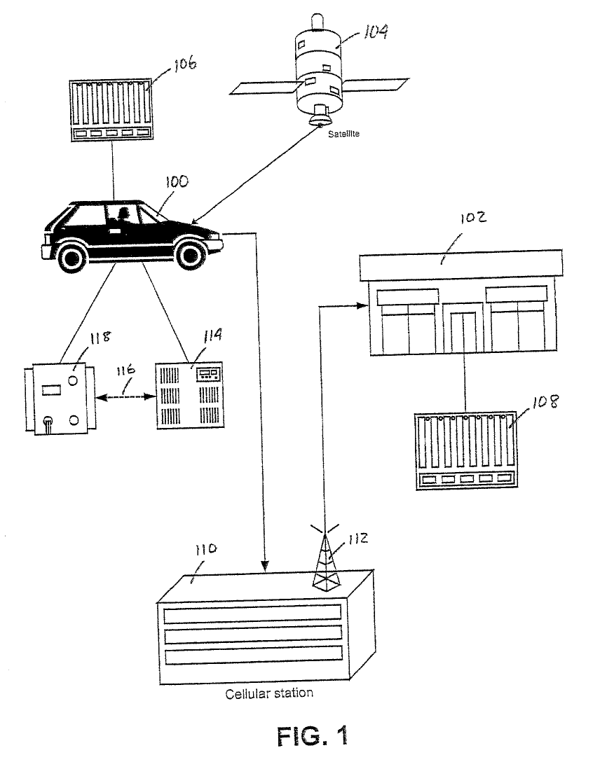

FIG. 1 schematically illustrates components of a system consistent with the present invention. In a preferred embodiment, a mobile source 100 transmits data to a call center 102. The data transmitted by the mobile source 100 can include position coordinates, mobility vectors, statistical accuracy of the position, and the initial time at which the transmission was made or measurements were taken. Examples of mobility vectors include velocity, acceleration, boost, or similar vectors associated with the movement of the mobile source. Data transmitted from the mobile source can also include a statistical representation of the accuracy of the position or mobility vector data. One such statistical representation would be a standard deviation. In a preferred embodiment, position and other information can be determined at the mobile source 100 using a transmission from a satellite 104. The satellite 104 can provide information to a GPS receiver system 114 at the mobile source 100. Another source of position and other information is from an INS 118 at the mobile source 100. The INS 118 can be integrated 116 with the GPS receiver system 114. The mobile source 100 can also have a processor 106 for conducting simple calculations and determining the mobility vector and other data for transmission. A similar processor 108 can also be included in the call center 102, providing a second position at which calculations can be performed. It should be noted that the call center 102 can also be another mobile source. Typically, the transmissions of data from the mobile source 100 can be relayed to the call center 102 through one or more cellular stations 100 or transmission towers 112.

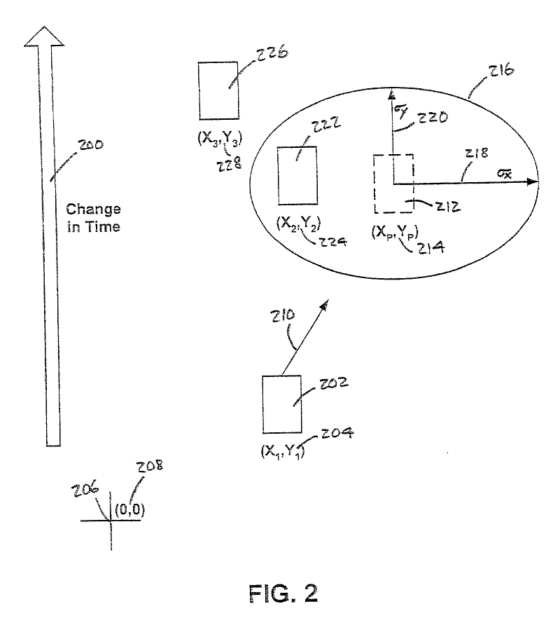

FIG. 2 conceptually illustrates an implementation of the present invention. With respect to FIG. 2, change in time is indicated by a block arrow 200. In FIG. 2, a mobile source is located at a first position 202 with first coordinates (X₁, Y₁) 204. The first coordinates 204 can be defined with respect to an arbitrary origin 206 with coordinates (0,0) 208. The mobile source at the first position 202 also provides a mobility vector 210 having both magnitude and direction. Using the mobility vector 210 and the first coordinates 204 a position is predicted 212 with predicted coordinates (Xₚ, Yₚ) 214. The predicted position 212 indicates the position to which it is expected the mobile source will have moved at a second time. In order to allow for an acceptable margin of error, a region of uncertainty 216 is dynamically defined at the second time based on the initial position coordinates 204, the mobility vector 210, and initial statistical accuracy at the first position 202. The dynamically defined region of uncertainty 216 has axes that represent the statistical accuracy of the predicted position. In FIG. 2, the statistical accuracy is represented as standard deviation values. The standard deviations are represented as σ_{X} 218 and σ_{Y} 220. In a preferred embodiment, the dynamically defined region of uncertainty 216 is defined in two dimensions as an ellipse with axes σ_{X} 218 and σ_{Y} 220. If the calculations were performed in three dimensions, the resulting dynamically defined region of uncertainty can be defined as an ellipsoid.

To conduct the authentication procedure, a reported position at a second time is compared to the predicted position and dynamically defined region of uncertainty. Continuing with FIG. 2, if the mobile source reports a second position 222 at a second time with coordinates (X₂, Y₂) 224 within the dynamically defined region of uncertainty 216, the mobile source is authenticated. If, however, the mobile source reports a different second position 226 at the second time, with coordinates (X₃, Y₃) 228 outside of the dynamically defined region of uncertainty 216, the mobile source is not authenticated.

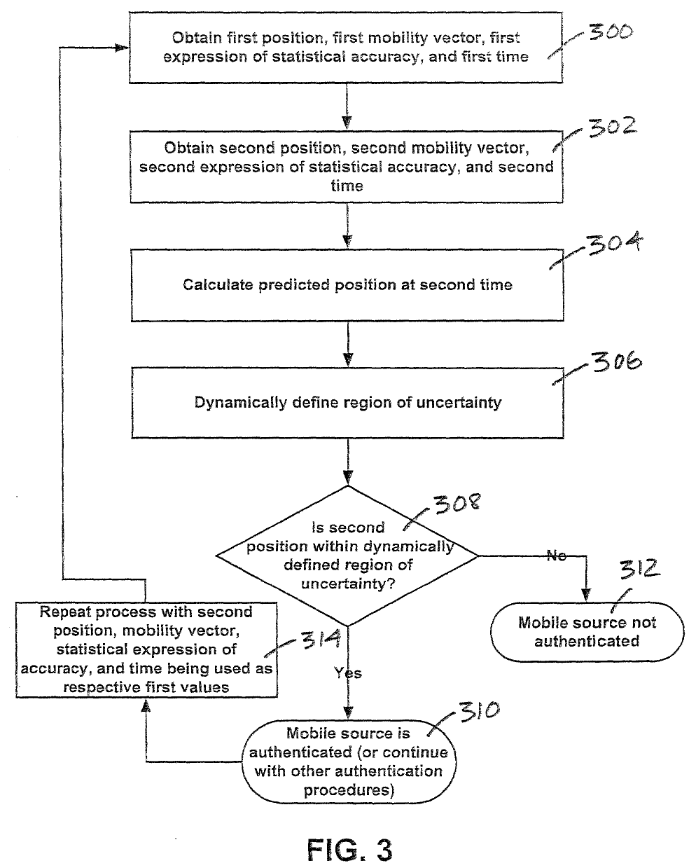

FIG. 3 illustrates an example of steps involved in a process consistent with the present invention. With respect to FIG. 3, the process begins with obtaining data defining a first position, a first mobility vector, an expression of statistical accuracy, and a first time 300. The values for the first position, mobility vector, and time can be determined by implementing a GPS receiver (or GPS integrated with INS) at the mobile source. In a preferred embodiment, the expression of statistical accuracy in step 300 is a standard deviation, σ, and is obtained from the GPS (or GPS integrated with INS) navigation filter equations.

Next, a second reported position, second mobility vector, and second time are obtained 302. A standard deviation can also be obtained from the GPS at the second time; however, the standard deviation and the second mobility vector may not need to be used until a subsequent step 314. Once the second reported position and second time are obtained, a predicted position and time differential can be calculated according to the following formulas:

D_{T}=T₂−T₁; Pₓ=P₁+V₁*D_{T}

where T₁ is the first time, T₂ is the second time, D_{T} is the time differential, P_{X} is the predicted position, P₁ is the first position, and V₁ is a velocity mobility vector. The calculations are expressed for one dimension only, but they can be repeated as may times as necessary depending on the dimensional requirements of the authentication procedure. It should also be noted that if additional or alternative mobility vectors are used, the equation for the predicted position will change. For example, if acceleration and velocity of the mobile source are used, the position can be predicted according to the following formula:

$${P}_{x} = {P}_{1} + {V}_{1} * {D}_{T} + \frac{1}{2} {A}_{1} * {D}_{T}^{2}$$

where A₁ is the acceleration of the mobile source at the first time.

In order to provide a margin of error in the predicted position or calculations, the standard deviation calculations are used dynamically to define a region of uncertainty that can be centered at the predicted position. In a preferred embodiment, a standard deviation for the predicted position is calculated according to the following equation:

$${σ}_{P} = \sqrt{{σ}_{x}^{2} + {( {σ}_{{v}_{x}} * {D}_{T} )}^{2}}$$

where σ_{P} is the standard deviation for the predicted position, σ_{X} is the standard deviation of the first position, σ_{V}_{ₓ} is the standard deviation of the first velocity, and D_{T} is the time differential. If acceleration is included, the equation for the standard deviation is:

$${σ}_{P} = \sqrt{{σ}_{x}^{2} + {( {σ}_{{v}_{x}} * {D}_{T} )}^{2} + \frac{1}{4} {( {σ}_{A x} * {D}_{T}^{2} )}^{2}}$$

where σ_{AX} is the standard deviation of the first acceleration, if available.

The dynamically defined region of uncertainty can then be defined with respect to the standard deviation values of the predicted position 306. The preferred embodiment defines the dynamically defined region of uncertainty as a ellipse (in two dimensions) or an ellipsoid (in three dimensions). A separate standard deviation value can be calculated in each dimension according to the preceding formulas.

Incorporating standard deviation values allows an expression of the confidence level of the authentication procedures. For example, if an ellipsoid is dynamically defined with the standard deviation values as axes, it represents a 68% confidence region. In other words, it can be said with 68% confidence that the predicted position falls between the predicted position coordinate value plus and minus the standard deviation. Similarly, using three times the standard deviation values can define a 99.8% confidence ellipsoid, or a region in which it can be said with 99.8% confidence that the predicted position is between the predicted position coordinate value plus and minus three times the standard deviation. Using these expressions of statistical confidence affords the present invention the ability to express results that quantify the reliability of the authentication procedure.

Continuing with FIG. 3, once the dynamically defined region of uncertainty has been established 306, the authentication procedure determines if the reported second position (from step 302) falls within the dynamically defined region of uncertainty 308. If the second position does fall within the dynamically defined region of uncertainty, the mobile source is authenticated 310; otherwise, the mobile source is not authenticated 312.

Also, as illustrated in FIG. 3, if the mobile source provides ongoing communications, the prior steps of FIG. 3 can be repeated at the next instance of time 314. When the process repeats, the data for the second position, second mobility vector, second standard deviation, and second time take the place of their respective corresponding counterparts in step 300. The authentication procedure then continues as illustrated in FIG. 3.

It should also be noted that the sequence of steps depicted in FIG. 3 can be varied without departing from the scope of the invention. For example, if a second time is already known (or if the time differential is a constant throughout the authentication procedure), the predicted position can be calculated before the second position is reported. Similarly, an alternative embodiment of the present invention can dynamically define the region of uncertainty centered at the second position (rather than at the predicted position). This alternative authentication procedure would then determine if the predicted position falls within the dynamically defined region of uncertainty encompassing the second position.

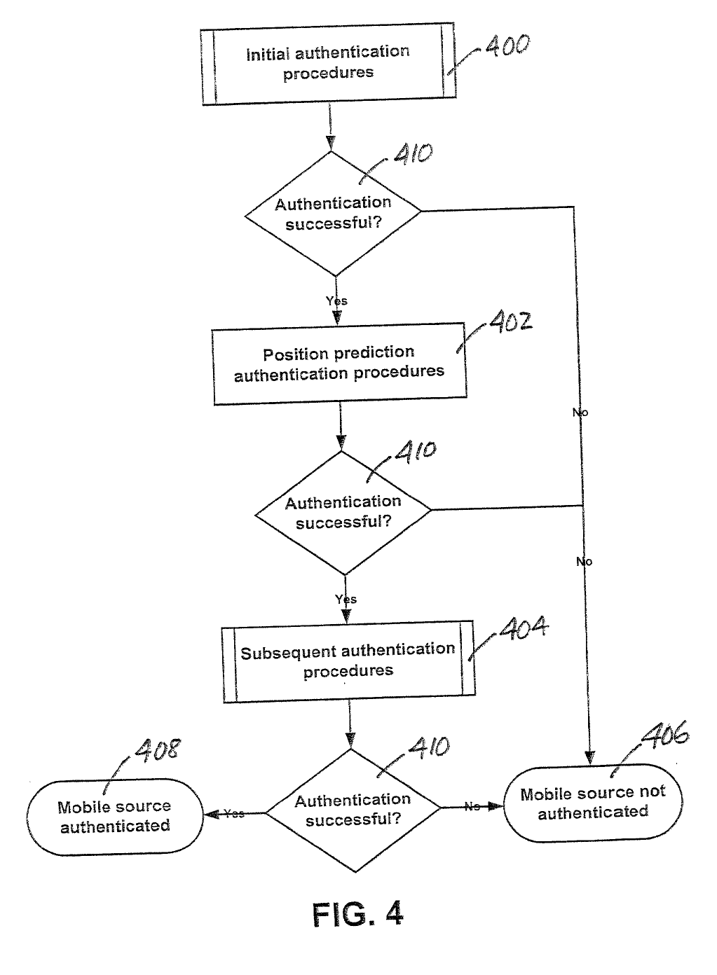

FIG. 4 illustrates that the position prediction authentication procedures of FIG. 3 can be implemented as part of a broader authentication process. Additional authentication procedures can be implemented before, after, or concurrent with the position prediction procedures described with respect to FIG. 3. In FIG. 4, the position prediction procedure is depicted as an intermediate procedure in the overall authentication process. First, initial authentication procedures 400 can be conducted, including obtaining an identification number or similar identification information from the mobile source. Next, position prediction authentication procedures similar to those of FIG. 3 can be conducted 402, followed by subsequent authentication procedures 404. If the mobile source fails any stage of the authentication process, the mobile source is not authenticated 406. The process can also be defined so that the mobile source will only be authenticated 408 if it passes each stage of the authentication process 410. The handling of unauthenticated mobile sources can depend on the particular implementation, and such procedures are outside the scope of the present invention.

The foregoing describes a preferred embodiment of a system and method for authentication. For illustration, the description assumes an application of the present invention for use in authenticating the identity of a mobile source. However, that is only one application of the present invention and is used for illustrative purposes only. Authentication of mobile sources in a wireless network can be thought of as adding a new dimension pertaining to the maintenance of what equates to “personal space.” This personal space can be used to authenticate the identity of the mobile source, or to ensure that each of multiple mobile sources on a mobile network do not violate the personal space of another mobile source. An exemplary application of this latter use would be in a collision avoidance system. Such a system uses the concept of identity to delineate and protect boundaries for a mobile source (such as a vehicle) using the wireless network. Position, velocity, time, related uncertainty data, and other information available from GPS or INS devices can be used to authenticate each communicating member of the network in terms of the risk represented to each member that another member may violate its personal space.

Accordingly, the previously described ongoing process of authentication can be useful not only to establish among communicants the veracity of a reported position of one to the other, but also as a means of alerting each to possible situations within their own system that require action. One such example would be in collision avoidance for a mobile vehicle. It is envisioned that a system such as the one presently described can have uses in a wide variety of systems, such as those designed for avoiding collisions, alerting a sleeping or non-attentive driver, enabling a cruise control to determine a suitable, dynamic cushion between nearby vehicles, identifying erratically moving or stationary vehicles, as well as authenticating a vehicle type, identification, and location based on navigation state reports. In a network infrastructure with multiple mobile sources, one mobile source can authenticate the integrity of its own moment-to-moment state based on its own navigation state information and information received from other mobile sources.

It will be obvious to those having skill in the art that many changes may be made to the details of the above-described embodiment of this invention without departing from the underlying principles thereof. The scope of the present invention should, therefore, be determined only by the following claims.

1. A method for authenticating a mobile source, the method comprising the steps of:
obtaining data defining a first position, a statistical accuracy of the first position, and a mobility vector of a mobile source at a first time;
obtaining data defining a second position of the mobile source at a second time;
determining a time differential between the second time and the first time;
predicting a position of the mobile source at the second time based on the first position, the statistical accuracy of the first position, the mobility vector, and the time differential;
dynamically defining a region encompassing the predicted position such that the dynamically defined region embodies a statistical representation of the accuracy of the predicted position; and
verifying the second position is within the dynamically defined region.

2. The method of claim 1 wherein the statistical representation of the accuracy of the predicted position is a standard deviation.

3. The method of claim 2 wherein the region is defined based on the first position, the statistical accuracy of the first position, the mobility vector, the time differential, and the standard deviation of the predicted position.

4. The method of claim 2 wherein the region is defined based on at least one of the first position, the statistical accuracy of the first position, the mobility vector, the time differential, or the standard deviation of the predicted position.

5. The method of claim 1 wherein the statistical representation is quantifiable to approximately sixty-eight percent confidence.

6. The method of claim 1 wherein the statistical representation is quantifiable to approximately 99.8% confidence.

7. The method of claim 1 wherein the mobility vector is chosen from a group consisting of velocity, acceleration, and boost.

8. A method for authenticating a mobile source, the method comprising the steps of:
receiving a first reported position and a first velocity of a mobile source at a first time;
predicting a second position of the mobile source at a second time based on the first position, the first velocity, and a time differential between the second time and the first time;
dynamically defining a region encompassing the predicted second position such that the dynamically defined region incorporates a statistical standard deviation of the predicted second position;
receiving a second reported position of the mobile source at the second time; and
verifying the second reported position is within the dynamically defined region encompassing the predicted second position.

9. The method of claim 8 further comprising the steps of:
receiving a first acceleration of the mobile source at the first time; and
using the first acceleration in the step of predicting a second position.
